(19) United States
(12) Patent Application Publication
(10) Pub. No.: US 2012/0313694 A1
(43) Pub. Date: Dec. 13, 2012

(54) INTERNAL VOLTAGE GENERATION CIRCUIT AND OPERATION METHOD THEREOF

(76) Inventors: Yu-Jong Noh, Gyeonggi-do (KR); Hyun-Chul Cho, Gyeonggi-do (KR)

(21) Appl. No.: 13/334,013

(22) Filed: Dec. 21, 2011

(30) Foreign Application Priority Data
Jun. 9, 2011 (KR) 10-2011-0055594

(51) Int. Cl. G05F 1/10

(52) U.S. Cl. 327/536

(57) ABSTRACT

An internal voltage generation circuit includes a pumping voltage generator including a plurality of pump units and configured to generate a final pumping voltage of a target voltage level, and an activation controller configured to control the number of activated pump units among the pump units based on the target voltage level.

### CROSS-REFERENCE TO RELATED APPLICATIONS

The present application claims priority of Korean Patent Application No. 10-2011-0055594, filed on Jun. 9, 2011, which is incorporated herein by reference in its entirety.

### BACKGROUND

1. Field

Exemplary embodiments of the present invention relate to a semiconductor designing technology, and more particularly, to an internal voltage generation circuit for generating an internal voltage through a pumping operation.

2. Description of the Related Art

Generally, a semiconductor memory device generates internal voltages of diverse voltage levels inside, and the generated internal voltages are supplied to internal circuits, that use the generated internal voltages, respectively. The internal voltage generation circuit for generating an internal voltage may be designed in various ways. Among them is a pumping circuit for generating an internal voltage through a pumping operation.

FIG. 1 is a block view illustrating a typical pumping circuit.

Referring to FIG. 1, the pumping circuit includes a plurality of pump units such as first to N^{th} pump units 110, 120, . . . , 130.

Each of the first to N^{th} pump units 110, 120, . . . , 130 performs a typical pumping operation, and each pump unit generates a different pumping voltage. In other words, the pumping voltage generated through a pumping operation performed in a first pump unit 110 is inputted to a second pump unit 120, and the second pump unit 120 receives the pumping voltage and generates a higher pumping voltage than the pumping voltage through a pumping operation. Accordingly, the voltage outputted from an N^{th} pump unit 130 is referred to as a final pumping voltage V_PP.

Meanwhile, more and more operations are performed by a semiconductor memory device and accordingly, diverse levels of internal voltages are to be generated. In order to easily obtain the diverse levels of internal voltages, a plurality of internal voltage generation circuits may be provided corresponding to the respective levels of internal voltages to be generated. This method, however, may increase area and current consumption for the generation of the internal voltages.

### SUMMARY

An exemplary embodiment of the present invention is directed to an internal voltage generation circuit that controls the activation operation of a plurality of pump units depending on a target voltage level of internal voltage.

Another exemplary embodiment of the present invention is directed to an internal voltage generation circuit that generates a target voltage level of internal voltage and uses minimum area.

Another exemplary embodiment of the present invention is directed to a semiconductor memory device that generates an operation voltage of a target voltage level and performs a data processing operation in response to the operation voltage.

In accordance with an exemplary embodiment of the present invention, an internal voltage generation circuit includes a pumping voltage generator including a plurality of pump units and configured to generate a final pumping voltage of a target voltage level, and an activation controller configured to control the number of activated pump units among the pump units based on the target voltage level.

The activation controller may selectively transfer a clock signal to the pump units in response to the control signals obtained by decoding the target voltage level.

In accordance with another exemplary embodiment of the present invention, an internal voltage generation circuit includes a pumping voltage generator including a plurality of pump units that are coupled in a form of chain and configured to output a final pumping voltage of a target voltage level from a last pump unit of the pump units, and an activation controller configured to control the number of activated pump units among the pump units based on the target voltage level.

The internal voltage generation circuit may further include a voltage supplier includes a pump unit corresponding to the target voltage level among the pump units with a source voltage.

In accordance with yet another exemplary embodiment of the present invention, a semiconductor memory device performing a data processing operation in response to an operation voltage includes a pumping voltage generator including a plurality of pump units and configured to generate a final pumping voltage having a target voltage level of the operation voltage, an activation controller configured to control the number of activated pump units among the pump units based on the target voltage level, and an internal voltage generator configured to generate the operation voltage by receiving and down-converting the final pumping voltage.

The operation voltage may include a program voltage, a pass voltage, and an erase voltage.

In accordance with still another exemplary embodiment of the present invention, a method for operating an internal voltage generation circuit including a first pump unit coupled with a second pump unit in a form of chain, includes generating a first pumping voltage of a first target voltage level by activating the second pump unit, and generating a second pumping voltage of a second target voltage level different from the first target voltage level by sequentially activating the first pump unit and the second pump unit.

The second pump unit may perform a pumping operation based on a predetermined source voltage corresponding to the first target voltage level, and perform a pumping operation based on a pumping voltage generated in the first pump unit corresponding to the second target voltage level.

The internal voltage generation circuit according to an exemplary embodiment of the present invention may optimize area and current consumption for the generation of internal voltage by controlling the number of activated pump units among a plurality of pump units depending on a target voltage level of internal voltage.

### BRIEF DESCRIPTION OF THE DRAWINGS

FIG. 1 is a block diagram illustrating a typical pumping circuit.

FIG. 2 is a block diagram illustrating an internal voltage generation circuit in accordance with an exemplary embodiment of the present invention.

FIG. 3 is a block diagram illustrating an example of an enabling controller 220 shown in FIG. 2.

FIG. 4 is a block diagram illustrating another example of the enabling controller 220 shown in FIG. 2.

FIG. 5 is a block diagram illustrating an example of a pumping voltage generator 210 shown in FIG. 2.

FIG. 6 is a block diagram illustrating another example of the pumping voltage generator 210 shown in FIG. 2.

FIG. 7 is an explanatory diagram briefly illustrating an operation of the pumping voltage generator 210 shown in FIG. 6.

FIG. 8 is a block diagram illustrating a semiconductor memory device including an internal voltage generation circuit fabricated in accordance with an exemplary embodiment of the present invention.

### DETAILED DESCRIPTION

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

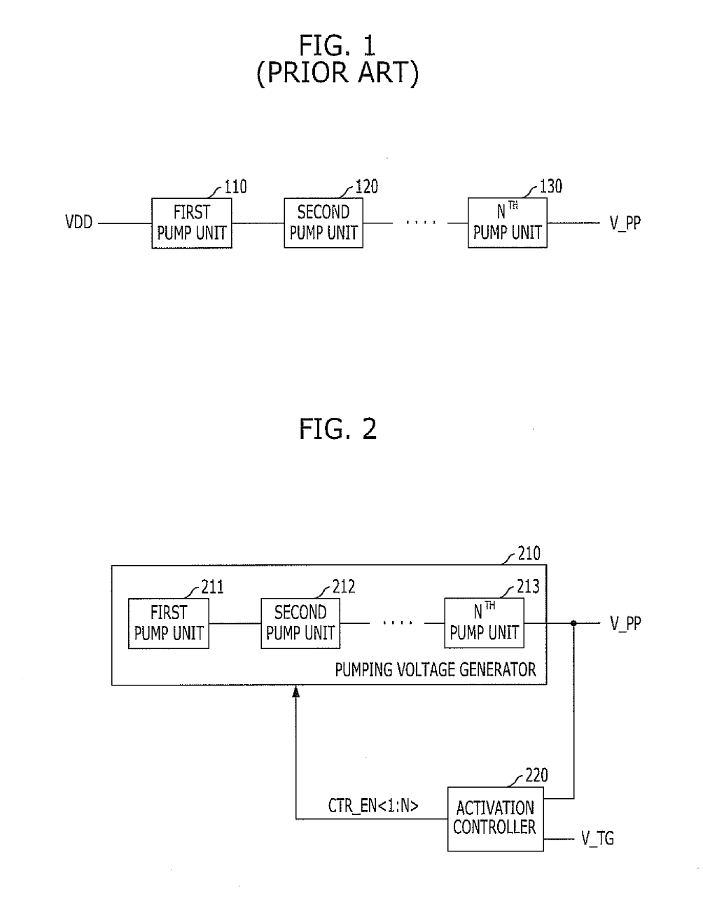

FIG. 2 is a block diagram illustrating an internal voltage generation circuit in accordance with an exemplary embodiment of the present invention.

Referring to FIG. 2, the internal voltage generation circuit includes a pumping voltage generator 210 and an activation controller 220.

The pumping voltage generator 210 generates a final pumping voltage V_PP which corresponds to a target voltage level, and the pumping voltage generator 210 includes a plurality of pump units that are connected in the form of chain, such as first to N^{th} pump units 211, 212, . . . , 213. The first to N^{th} pump units 211, 212, . . . , 213 is activated under the control of first to N^{th} enabling control signals CTR_EN<1:N>, respectively. The activation controller 220 generates the first to N^{th} enabling control signals CTR_EN<1:N> in response to the final pumping voltage V_PP and a target voltage V_TG. Here, the target voltage V_TG has a voltage level corresponding to the target voltage level which the final pumping voltage V_PP is to reach.

The internal voltage generation circuit in accordance with the embodiment of the present invention may use a different number of pump units for a pumping operation among the first to N^{th} pump units 211, 212, . . . , 213 in response to the first to N^{th} enabling control signals CTR_EN<1:N>. Here, since the activation or deactivation of the first to N^{th} enabling control signals CTR_EN<1:N> depends on the target voltage level, the number of activated pump units during a pumping operation is different depending on the target voltage level.

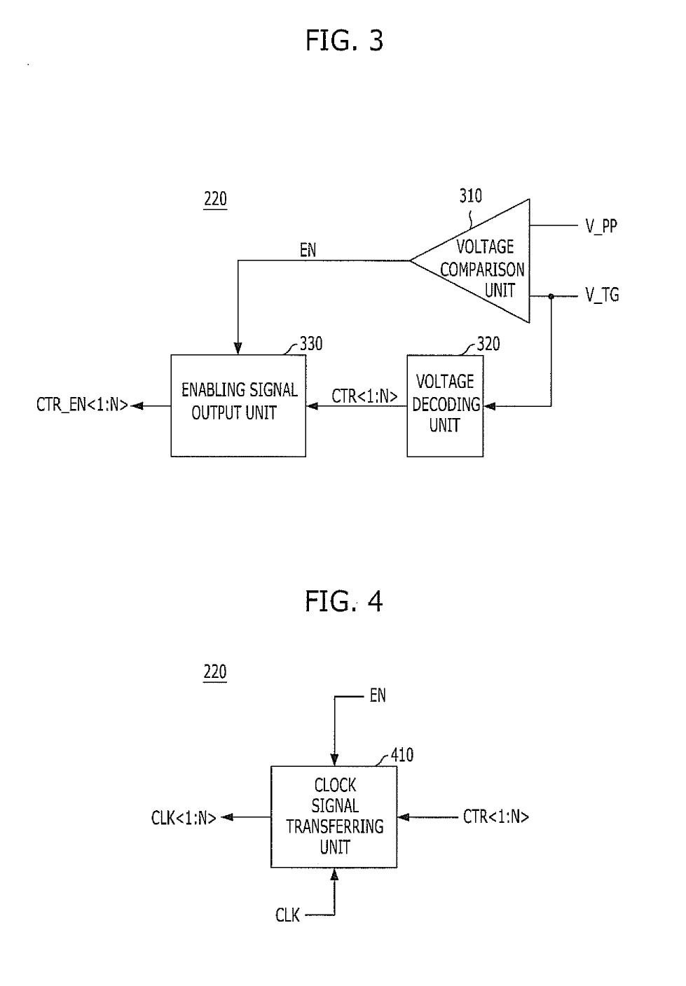

FIG. 3 is a block diagram illustrating an example of the activation controller 220 shown in FIG. 2.

Referring to FIG. 3, the activation controller 220 outputs a plurality of control signals CTR<1:N> corresponding to the target voltage V_TG as the first to N^{th} enabling control signals CTR_EN<1:N>. The activation controller 220 includes a voltage comparison unit 310, a voltage decoding unit 320 and an enabling signal output unit 330.

The voltage comparison unit 310 generates an enabling signal EN by comparing the voltage level of the final pumping voltage V_PP with the voltage level of the target voltage V_TG. The voltage decoding unit 320 generates a plurality of control signals CTR<1:N> by decoding the target voltage V_TG. The enabling signal output unit 330 includes an enabling signal output element which outputs the control signals CTR<1:N> as first to N^{th} enabling control signals CTR_EN<1:N> in response to the enabling signal EN. Here, the first to N^{th} enabling control signals CTR_EN<1:N> are signals for activating the first to N^{th} pump units 211, 212, . . . , 213 shown in FIG. 2, respectively. Therefore, according to the embodiment of the present invention, the internal voltage generation circuit has a different number of pump units among the first to N^{th} pump units 211, 212, . . . , 213 activated in response to the first to N^{th} enabling control signals CTR_EN<1:N> corresponding to the target voltage V_TG.

Referring to FIGS. 2 and 3, the activation controller 220 in accordance with the exemplary embodiment of the present invention may be designed in various ways. For example, if the first to N^{th} pump units 211, 212, . . . , 213 perform a pumping operation based on a clock signal, the activation controller 220 may includes a clock signal transferring unit 410 shown in FIG. 4, instead of the enabling signal output unit 330.

FIG. 4 is a block diagram illustrating another example of the activation controller 220 shown in FIG. 2. The activation controller 220 includes the voltage comparison unit 310 and the voltage decoding unit 320 shown in FIG. 3, which are omitted from the FIG. 4 for the sake of convenience.

Referring to FIG. 4, the activation controller 220 includes a clock signal transferring unit 410 for transferring a clock signal CLK to the pumping voltage generator 210 in response to the enabling signal EN and the control signals CTR<1:N>. A plurality of output clock signals CLK<1:N> outputted from the clock signal transferring unit 410 are transferred to the first to N^{th} pump units 211, 212, . . . , 213 of FIG. 2, respectively, as the first to N^{th} enabling control signals CTR_EN<1:N>. The output clock signals CLK<1:N> are selectively transferred in response to the control signals CTR<1:N> in a period where the enabling signal EN is activated, and a pump unit receiving the corresponding output clock signal performs a pumping operation. After all, the internal voltage generation circuit in accordance with the embodiment of the present invention has a different number of output clock signals transferred in response to the target voltage V_TG, and this signifies that the number of activated pump units among the first to N^{th} pump units 211, 212, . . . , 213 may be different depending on the target voltage V_TG.

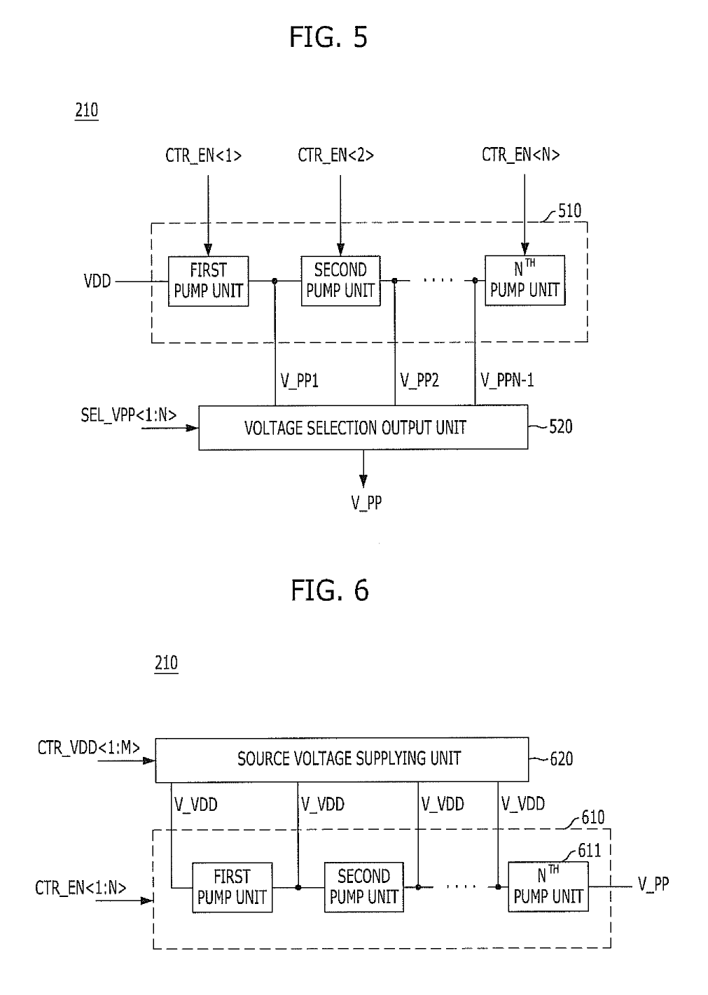

FIG. 5 is a block diagram illustrating an example of the pumping voltage generator 210 shown in FIG. 2.

Referring to FIG. 5, the pumping voltage generator 210 includes a plurality of pump units 510 and a voltage selection output unit 520.

The pump units 510 perform a pumping operation in response to the above-described first to N^{th} enabling control signals CTR_EN<1:N> and generates a plurality of pumping voltages V_PP1, V_PP2, . . . , V_PPN-1 through the pumping operation. Subsequently, the voltage selection output unit 520 outputs any one of the pumping voltages V_PP1, V_PP2, . . . , V_PPN-1 generated in the pump units 510 as the final pumping voltage V_PP in response to a plurality of voltage selection signals SEL_VPP<1:N>. Here, the voltage selection signals SEL_VPP<1:N> may be a signal corresponding to a target voltage level, and after all, the voltage selection output unit 520 selects and outputs a pumping voltage corresponding to the target voltage level among the pumping voltages V_PP1, V_PP2, . . . , V_PPN-1 as the final pumping voltage V_PP.

FIG. 6 is a block diagram illustrating another example of the pumping voltage generator 210 shown in FIG. 2.

Referring to FIG. 6, the pumping voltage generator 210 includes a plurality of pump units 610 and a source voltage supplying unit 620.

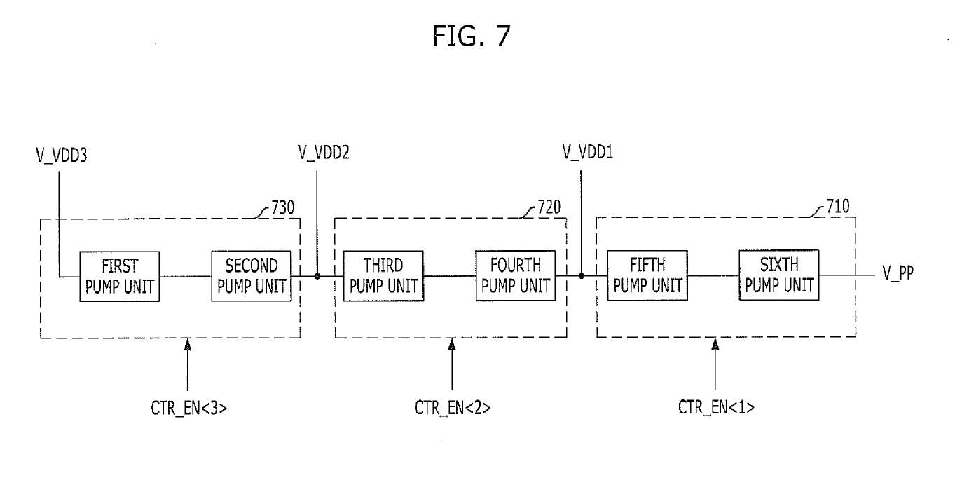

The pump units 610 perform a pumping operation in response to the above-described first to N^{th} enabling control signals CTR_EN<1:N>. The source voltage supplying unit 620 provides the pump units 610 with a source voltage, e.g., a power supply voltage V_VDD, in response to a supply control signal CTR_VDD<1:M>, where M is a natural number equal to or smaller than N. Here, the supply control signal CTR_VDD<1:M> may be a signal corresponding to a target voltage level, and this will be described in detail below with reference to FIG. 7. The source voltage V_VDD supplied to the pump units 610 are the basic voltage for a pumping operation, and the pump units 610 may have the same voltage level or they may have different voltage levels according to how they are designed, as the levels of the basic voltage.

FIG. 7 is an explanatory diagram briefly illustrating an operation of the pumping voltage generator 210 shown in FIG. 6. For the purpose of description, a case that six pump units are grouped into two of them for each group, and the target voltage levels of the final pumping voltage V_PP are approximately 8V, approximately 16V and approximately 24V is taken as an example.

Hereafter, a circuit operation is briefly described with reference to FIGS. 6 and 7.

First of all, a case that the target voltage level of the final pumping voltage V_PP is approximately 8V is described. In this case, a first enabling control signal CTR_EN<1 is activated in response to the target voltage level of approximately 8V, while second and third enabling control signals CTR_EN<2:3> are deactivated. Therefore, a first pump group 710 is activated in response to the first enabling control signal CTR_EN<1>. Here, the source voltage supplying unit 620 of FIG. 6 provides the first pump group 710 with a first source voltage V_VDD1 in response to the supply control signal CTR_VDD<1:M>, and the first pump group 710 performs a pumping operation based on the first source voltage V_VDD1.

Subsequently, a case that the target voltage level of the final pumping voltage V_PP is approximately 16V is described. In this case, first and second enabling control signals CTR_EN<1:2> are activated in response to the target voltage level of approximately 16V, while a third enabling control signal CTR_EN<3> is deactivated.

Therefore, first and second pump groups 710 and 720 are activated. Here, the source voltage supplying unit 620 of FIG. 6 provides the second pump group 720 with a second source voltage V_VDD2, and the second pump group 720 performs a pumping operation earlier than the first pump group 710 and the first pump group 710 performs a pumping operation based on the pumping voltage generated in the second pump group 720.

Lastly, when the target voltage level of the final pumping voltage V_PP is approximately 24V, the first to third enabling control signals CTR_EN<1:3> are all activated to activate the first to third pump groups 710, 720, and 730, and the source voltage supplying unit 620 provides the third pump group 730 with a third source voltage V_VDD3.

Meanwhile, as shown in FIGS. 6 and 7, the final pumping voltage V_PP is outputted from a pump unit at the end of the pump units in this embodiment of the present invention. In this structure, the voltage selection output unit 520 shown in FIG. 5 may not be provided and furthermore, a plurality of voltage selection signals SEL_VPP<1:N> may not be generated for controlling the voltage selection output unit 520. Here, although the voltage selection signals SEL_VPP<1:N> are to have higher voltage levels than a voltage level of voltage to be transferred, since they are not to be generated in the structures of FIGS. 6 and 7, it may occupy a relatively small area.

As described above, in the internal voltage generation circuit in accordance with the exemplary embodiment of the present invention, the number of activated pump units may be controlled depending on the target voltage level of the final pumping voltage V_PP and accordingly, excess current consumption may be prevented.

Meanwhile, the final pumping voltage V_PP obtained by controlling the number of pump units may be modified into a plurality of internal voltages having a predetermined voltage level through a down-conversion operation. Here, the down-conversion operation is carried out to remove a ripple component that is generated through a pumping operation. Therefore, a stable internal voltage may be obtained by performing the down-conversion operation after a pumping operation.

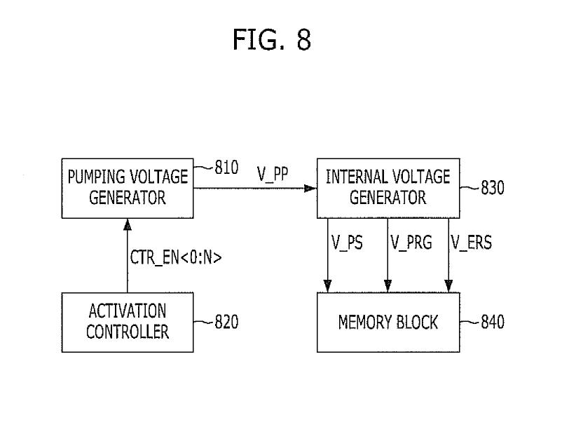

FIG. 8 is a block view illustrating a semiconductor memory device including an internal voltage generation circuit fabricated in accordance with an embodiment of the present invention.

Referring to FIG. 8, the semiconductor memory device includes a pumping voltage generator 810, an activation controller 820, an internal voltage generator 830, and a memory block 840. Since the pumping voltage generator 810 and the activation controller 820 are described in the above embodiments, further description on them is not provided here.

The internal voltage generator 830 receives a final pumping voltage V_PP, generated in the pumping voltage generator 810, and generates operation voltage, e.g., pass voltage V_PS, program voltage V_PRG, and erase voltage V_ERS, by performing a down conversion operation. Subsequently, the memory block 840 is an area where a memory cell array is disposed. The memory block 840 performs a data driving/processing operation in response to pass voltage V_PS, program voltage V_PRG, or erase voltage V_ERS. Here, the data driving operation may include a data program operation and a data erase operation. In other words, the memory block 840 performs a data program operation in response to the pass voltage V_PS and the program voltage V_PRG and performs a data erase operation in response to the erase voltage V_ERS.

Here, when the pass voltage V_PS, the program voltage V_PRG, and the erase voltage V_ERS are generated based on one final pumping voltage V_PP, the target voltage level of the final pumping voltage V_PP may be set depending on the highest voltage level among those of the pass voltage V_PS, the program voltage V_PRG, and the erase voltage V_ERS.

The internal voltage generation circuit according to an embodiment of the present invention may generate diverse voltage levels of internal voltage without an increase in the area thereof and prevent excess current consumption through an efficient operation.

While the present invention has been described with respect to the specific embodiments, it will be apparent to those skilled in the art that various changes and modifications may be made without departing from the spirit and scope of the invention as defined in the following claims.

What is claimed is:

1. An internal voltage generation circuit, comprising:
a pumping voltage generator including a plurality of pump units and configured to generate a final pumping voltage of a target voltage level; and
an activation controller configured to control the number of activated pump units among the pump units based on the target voltage level.

2. The internal voltage generation circuit of claim 1, further comprising:
a voltage selection output unit configured to select and output a pumping voltage having a voltage level corresponding to the target voltage level among a plurality of pumping voltages generated in the pump units as the final pumping voltage.

3. The internal voltage generation circuit of claim 1, wherein the activation controller is configured to output a plurality of enabling control signals, which respectively correspond to the pump units, in response to the target voltage level.

4. The internal voltage generation circuit of claim 1, wherein the activation controller comprises:
a voltage comparison unit configured to generate an enabling signal by comparing the final pumping voltage with a target voltage of the target voltage level;
a voltage decoding unit configured to generate a plurality of control signals obtained by decoding the target voltage level; and
an enabling signal output unit configured to output the control signals as a plurality of enabling control signals corresponding to the pump units in response to the enabling signal.

5. The internal voltage generation circuit of claim 1, wherein the activation controller is configured to selectively transfer a clock signal to the pump units in response to control signals obtained by decoding the target voltage level.

6. An internal voltage generation circuit, comprising:
a pumping voltage generator including a plurality of pump units that are coupled in a form of chain and configured to output a final pumping voltage of a target voltage level from a last pump unit of the pump units; and
an activation controller configured to control the number of activated pump units among the pump units based on the target voltage level.

7. The internal voltage generation circuit of claim 6, further comprising:
a voltage supplier configured to provide a pump unit among the pump units with a supply voltage based on the target voltage level.

8. The internal voltage generation circuit of claim 7, wherein the pump units are grouped into a plurality of pump groups, each including a predetermined number of pump units, and
the voltage supplier is configured to generate supply voltages in number corresponding to the number of pump groups.

9. A semiconductor memory device performing a data processing operation in response to an operation voltage, comprising:
a pumping voltage generator including a plurality of pump units and configured to generate a final pumping voltage having a target voltage level of the operation voltage;
an activation controller configured to control the number of activated pump units among the pump units based on the target voltage level; and
an internal voltage generator configured to generate the operation voltage by receiving and down-converting the final pumping voltage.

10. The semiconductor memory device of claim 9, wherein the operation voltage comprises a program voltage, a pass voltage, and an erase voltage.

11. The semiconductor memory device of claim 9, further comprising:
a voltage selection output unit configured to select and output a pumping voltage having a voltage level corresponding to the target voltage level among a plurality of pumping voltages generated in the pump units as the final pumping voltage.

12. The semiconductor memory device of claim 9, wherein the activation controller is configured to output a plurality of enabling control signals, which respectively correspond to the pump units, in response to the target voltage level.

13. The semiconductor memory device of claim 9, wherein the activation controller comprises:
a voltage comparison unit configured to generate an enabling signal by comparing the final pumping voltage with a target voltage of the target voltage level;
a voltage decoding unit configured to generate a plurality of control signals obtained by decoding the target voltage level; and
an enabling signal output unit configured to output the control signals as a plurality of enabling control signals corresponding to the pump units in response to the enabling signal.

14. The semiconductor memory device of claim 9, wherein the activation controller is configured to selectively transfer a clock signal to the pump units in response to control signals obtained by decoding the target voltage level.

15. The semiconductor memory device of claim 12, wherein the pumping voltage generator includes the pump units that are coupled in a form of chain and is configured to output the final pumping voltage having the target voltage level from a last pump unit of the pump units.

16. The semiconductor memory device of claim 15, further comprising:
a voltage supplier configured to provide a pump unit among the pump units with a supply voltage based on the target voltage level.

17. The semiconductor memory device of claim 16, wherein the pump units are grouped into a plurality of pump groups, each including a predetermined number of pump units, and
the voltage supplier is configured to generate supply voltages tin number corresponding to the number of pump groups.

18. The semiconductor memory device of claim 9, wherein the operation voltage comprises a plurality of operation voltages and the target voltage level is set based on the highest voltage level among respective target voltage levels of the plurality of operation voltages.

19. A method for operating an internal voltage generation circuit including a first pump unit coupled with a second pump unit in a form of chain, comprising:
generating a first pumping voltage of a first target voltage level by activating the second pump unit; and
generating a second pumping voltage of a second target voltage level different from the first target voltage level by sequentially activating the first pump unit and the second pump unit.

20. The method of claim 19, wherein, in the generating the first pumping voltage, the second pump unit is activated to perform a pumping operation using a first supply voltage.

21. The method of claim 20, wherein, in the generating the second pumping voltage, the first pump unit is activated to perform a pumping operation using a second supply voltage, and
the second pump unit is activated to perform a pumping operation using an output voltage of the first pump unit.

22. The method of claim 19, wherein the second target voltage level is higher than the first target voltage level.

23. The method of claim 19, further comprising:
generating a plurality of internal voltages by down-converting the first or second pumping voltage.
